(19) United States
(12) Patent Application Publication
(10) Pub. No.: US 2004/0228230 A1
(43) Pub. Date: Nov. 18, 2004

(54) Drive unit for driving objective lens of optical head

(75) Inventor: Tsutomu Matsui, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO.,LTD.

(21) Appl. No.: 10/829,226

(22) Filed: Apr. 22, 2004

(30) Foreign Application Priority Data
Apr. 23, 2003 (JP) P2003-118523

(51) Int. Cl. G11B 7/00

(52) U.S. Cl. 369/44.16

(57) ABSTRACT

A drive unit for driving an objective lens of an optical head includes: a lens holder 12 for holding an objective lens; a plurality of coils Tr1, F11, F21, Tr2, F21, F22, which are provided on two sides 12a, 12b of the lens holder 12 by three coils; a plurality of wires of the first to the third wire W1 to W3 for supplying electric currents to the coils and for supporting the lens holder 12; magnets 31, 32 for generating a magnetic field in the coil portions, wherein the plurality of coils includes a first system coil F11, F12 connected between the first wire W1 and the common wire W4, a second system coil F21, F22 connected between the second wire W2 and the common wire W4, and a third system coil Tr1, Tr2 connected between the is third wire W3 and the common wire W4.

### BACKGROUND OF THE INVENTION

1. Field of the Invention

The present invention relates to a drive unit for driving an objective lens of an optical head provided in a disk drive unit for driving an optical disk or optical magnetic disk. More particularly, the present invention relates to a drive unit for driving an objective lens of an optical head in which a lens of a high numerical aperture, which requires to adjust the tilting angle, is used.

2. Description of the Related Art

Concerning the optical disk drive unit, the following technique has been known. A positional correction is made by displacing the objective lens of the optical head in the focusing direction of light and also displacing the objective lens of the optical head in the radial direction (the tracking direction) of the disk, which is perpendicular to the row of data on the disk.

Concerning the configuration for making a correction in the focusing direction and the tracking direction, the following technique is disclosed in JP-A-8-273176 and in JP-A-2001-229554. A coil is provided on the side of the lens holder for holding the objective lens, and a magnet is provided outside the lens holder. Further, the lens holder is supported by wires so that the lens holder can be displaced in the focusing and the tracking direction, and an electric current is made to flow in the coil via the wires. Due to the above configuration, it is possible to realize a compact configuration capable of conducting a positional correction at a low manufacturing cost.

In the positional correction having the above configuration, it is common to use a pair of wires in which an electric current flows for focusing correction and to use a pair of wires in which an electric current flows for tracking correction. That is, it is common to use four wires in total. When the lens holder is supported by the four wires as described above, a positional correction can be conducted while the lens holder is being relatively stably supported.

In this connection, in the case of a disk drive unit by which recording and regeneration are conducted at high speed, in order to increase a quantity of emergent light, it is necessary to use an objective lens of a high numerical aperture for the optical head. In the case of using the objective lens of a high numerical aperture, a small inclination between the disk face and the optical axis, which is caused by warp on the disk, has a bad influence on the diaphragm of the beam. Therefore, it is necessary to conduct a correction of the inclination angle (the tilting angle direction) of the objective lens according to the inclination of the disk in the radial direction in addition to the positional correction conducted in the focusing and the tracking direction.

### SUMMARY OF THE INVENTION

Conventionally, the following optical head is provided, in which the correction of three axes in the focusing direction, the tracking direction and the tilting angle direction is conducted. That is, the entire structure for conducting the positional correction in the focusing and the tracking direction, which is described in JP-A-8-273176 and in JP-A-2001-229554, is arranged on a board capable of being displaced in the tilting angle direction, and this board is rotated in the tilting angle direction by the moving magnet system (the drive system in which driving is conducted by a fixed coil and a magnet capable of being displaced).

However, when the above configuration is adopted, the size of the objective lens driving mechanism is increased, which causes a rise in the manufacturing cost of the optical head.

Further, the following configuration is proposed. A special coil capable of correcting an inclination angle is provided in the lens holder differently from the coils for conducting the correction in the focusing and the tracking direction, and two wires are added so as to make an electric current flow in this coil.

However, in the above configuration, it is necessary to provide a special thin coil so that a drive force in the tilting angle direction can be generated and the attaching work can be easily performed, which causes a rise in the costs of parts. Further, in order to drive three axes, it is necessary to provide six wires. Therefore, the assembling work becomes difficult compared with the assembling work of the configuration in which four wires are used. To be in more detail, it is necessary to conduct assembling while tension of each wire for supporting the lens holder is maintained constant. However, in the case of six wires, the wires interfere with each other. Therefore, it is difficult to maintain the tension of each wire constant. Further, due to the fluctuation of tension of each wire, it is difficult to obtain a stable operation characteristic.

It is an object of the present invention to provide a compact drive unit for driving an objective lens of an optical head, the objective lens of which is driven by three axes in the focusing direction, the tracking direction and the tilting angle direction, the operation characteristic of which is stable, at a low manufacturing cost.

In order to accomplish the above object, according to the present invention, there is provided a drive unit for driving an objective lens of an optical head including: a lens holder for holding the objective lens; a plurality of coils provided on sides of the lens holder; a plurality of wires that supplies electric currents to the coils and supports the lens holder; and a magnet that generates a magnetic field in a portion where the coils are provided, wherein the plurality of wires include a first wire, a second wire, a third wire and a common wire, wherein the plurality of coils include a first system coil connected between the first wire and the common wire, a second system coil connected between the second wire and the common wire, and a third system coil connected between the third wire and the common wire, and wherein the lens holder is to be displaced in a focusing direction, in a tilting angle direction and in a tracking direction independently from each other by the three electric currents respectively flowing in the first, the second and the third wire.

According to the above configuration, it is possible to drive the three axes by the coils of the lens holder and the magnets outside. Further, the lens holder can be supported by four wires. Therefore, the objective lens drive unit can be made compact and further the manufacturing cost can be reduced and furthermore a stable operation characteristic can be obtained.

Specifically, the following structure may be adopted. The first to the third system are respectively composed of two coils for each system. In each system, one coil is provided on one side of the lens bolder, and the other coil is provided on the other side of the lens holder.

Due to the above structure, drive forces can be provided on both sides of the lens holder, so that a more stable operation characteristic can be provided.

More specifically, on one side of the lens holder, the first system coil and the second system coil may be arranged being formed into a line in a direction perpendicular to the focusing direction, and the third system coil may be arranged at a position displaced in the focusing direction from the central position between the first system coil and the second system coil.

Due to the above structure, three axes can be driven by the coils, the number of which is necessary at the minimum.

The magnet is composed of an integral ferromagnetic body, the ferromagnetic body being divided into four regions by x-axis and y-axis, which are perpendicular to each other, on one face, each region being magnetized to N-pole or S-pole so that the regions adjacent to each other can be magnetized to a different polarity, the one face being opposed to the side of the lens holder in which the coil is provided, the x-axis being opposed to a straight line connecting the centers of the first system coil and the second system coil, the y-axis being opposed to a straight line passing at the center of the third system coil.

Due to the above configuration, the driving of the objective lens in the focusing direction can be controlled by an added value or subtracted value of the electric currents flowing in the first and the second wire, the driving of the objective lens in the tilting angle direction can be controlled by a subtracted value or added value of the electric currents flowing in the first and the second wire, and the driving of the objective lens in the tracking angle direction can be controlled by an electric current flowing in the third wire.

Further, it is preferable that the plurality of coils are square flat coils of the same size. When the sizes of the coils are the same, the costs of parts can be reduced. When the square coils are used, the area can be reduced smaller than that of the circular coils so as to stably obtain a higher driving force.

### BRIEF DESCRIPTION OF THE DRAWINGS

The above objects and advantages of the present invention will become more apparent by describing a preferred embodiment thereof in detail with reference to the accompanying drawings, wherein:

FIG. 1 is a separate perspective view showing a drive unit for driving an objective lens of an embodiment of the present invention;

FIG. 2 is a plan view showing the drive unit of an objective lens shown in FIG. 1;

FIG. 3 is a view for explaining a relation of the arrangement of square flat coils, which are fixed to a lens holder, and magnetic poles which appear on a magnet, wherein FIG. 3A is a front view of the faces of the square flat coils opposing to the magnet, FIG. 3B is a front view of the face of the magnet, and FIG. 3C is a separate perspective view showing directions of both the square flat coils and the magnet when they are opposed to each other;

FIG. 4 is a view of a portion of the lens holder to which the square flat coils of the lens holder are fixed, wherein the view is taken from the side;

FIG. 5 is a view showing an example of the circuit diagram in which a connecting relation between the square flat coils, which are provided in the lens holder, and the wires is shown;

FIG. 6 is a front view showing another example of arranging the square flat coils fixed to the lens holder;

FIG. 7 is a separate perspective view showing a variation of the drive unit for driving an objective lens of the present invention; and

FIG. 8 is a side view showing operation of the yokes, wherein FIG. 8 is a side view taken in the direction of arrow A in FIG. 7.

### DETAILED DESCRIPTION OF THE PREFERRED EMBODIMENTS

Referring to the drawings, an embodiment of the present invention will be explained below.

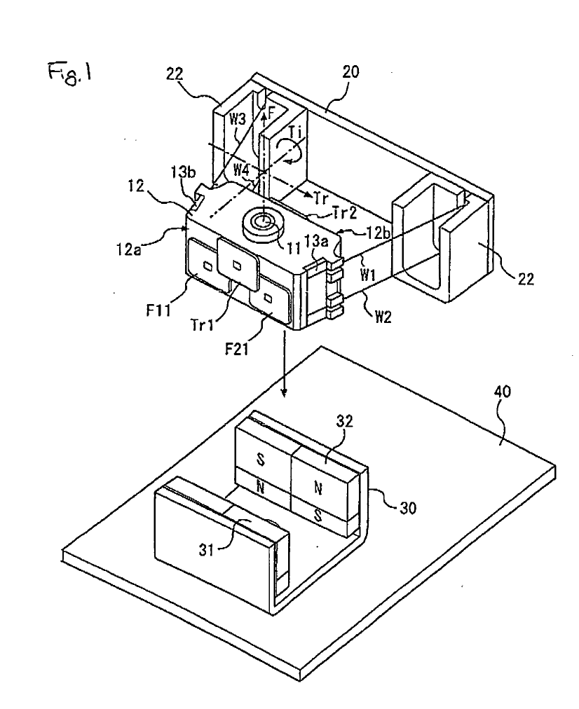

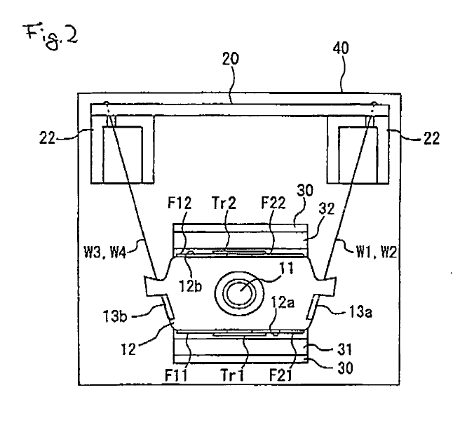

FIG. 1 is a separate perspective view showing a drive unit for driving an objective lens of an optical head of the embodiment of the present invention, and FIG. 2 is a plan view showing the drive unit.

The drive unit for driving an objective lens of an optical head of this embodiment is incorporated into DVD (Digital Versatile Disk) drive unit capable of recording data such as DVD-R or DVD-RW and conducts a correction in three axial directions when the objective lens of the optical head (optical pickup) is minutely driven in the focusing direction F, the radial direction (tracking direction) Tr perpendicular to the row of data on the disk and the tilting angle direction Ti corresponding to the inclination of the disk in the radial direction.

The drive unit for driving an objective lens of this embodiment includes: an objective lens 11; a lens holder 12 for holding the objective lens 11; square flat coils F11, F21, Tr1, F12, F22, Tr2, three square flat coils F11, F21, Tr1 being provided on one side 12a of the lens holder 12, three square flat coils F12, F22, Tr2 being provided on the other side 12b of the lens holder 12 which is the opposite side to the side 12a; four wires W1 to W4 for supporting the lens holder 12 and supplying an electric current to each coil; a wire base board 20 to which these four wires W1 to W4 are fixed; two magnets 31, 32 arranged being opposed to the side of the lens holder 12 on which the coils are provided; a magnet holder 30 for holding the magnets; and a base frame 40 to which the magnet holder 30 and the wire base board 20 are fixed.

In the lens holder 12, the printed board 13a, to which wires W1 and W2 are connected, and the printed board 13b, to which wires W3 and W4 are connected, are respectively put in recess portions. Due to the foregoing, wires W1 to W4 and the lens holder 12 are fixed to each other at an appropriate position, and further wires W1 to W4 and the wiring in the lens holder 12 are electrically connected to each other.

As shown in FIG. 2, wires W1 to W4 are obliquely extended from the lens holder 12, and one end portion of each wire is soldered to the wire base board 20. On the wire base board 20, the gel boxes 22 are provided in ranges in which wires W1 to W4 pass, and buffer gel for preventing the occurrence of resonance is charged into the gel boxes 22. Since wires W1 to W4 are arranged passing in this buffer gel (not shown in the drawing), resonance can be prevented.

Each square flat coil F11, F21, Tr1, F12, F22, Tr2 is a thin type coil round which a lead wire is wound along each side of the square. The sizes and the numbers of winding of the coils are the same.

Each magnet 31, 32 is composed of one ferromagnetic body, the shape of which is a rectangular parallelepiped. A face of each magnet 31, 32 opposing to the coil is divided into four regions, and the magnet is magnetized so that N-pole and S-pole can alternately appear in each region. In this connection, it is possible to compose the same magnetic field with four magnets.

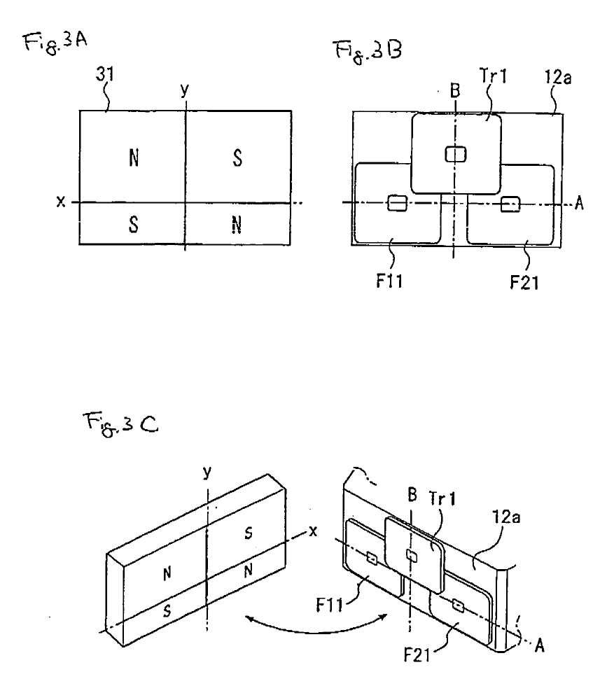

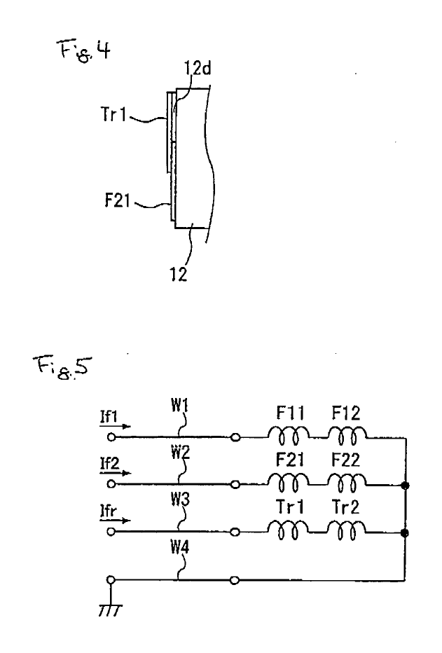

FIGS. 3A through 3C are views for explaining a relation of the arrangement of the square flat coils and the magnetic poles which appear on the magnet. FIG. 3A is a front view of the face of the magnet opposing to the lens holder 12, FIG. 3B is a front view of the face of the square flat coil opposing to the magnet, and FIG. 3C is a separate perspective view showing directions of both the square flat coils and the magnet when they are opposed to each other. FIG. 4 is a view of a portion of the lens holder 12 to which coils F11, F21, Tr1 are fixed, wherein the view is taken from the side.

As shown in FIG. 3B, the first coil F11 and the second coil F21 are attached onto one side 12a of the lens holder 12 in such a manner that the first coil F11 and the second coil F21 are separate from each other by a small interval and located symmetrically in the lateral direction at positions biased downward (in the direction opposite to the focusing direction) The third coil Tr1 is attached at a position biased upward from the central position between coils F11 and F21 so that the third coil Tr1 can not overlap with a straight line connecting the centers of the first coil F11 and the second coil F21.

In this case, the range, in which the first coil F11 is attached, and the range, in which the third coil Tr1 is attached, partially overlap with each other, and further the range, in which the second coil F21 is attached, and the range, in which the third coil Tr1 is attached, partially overlap with each other. However, since the first and the second coil F11, F21 and the third coil Tr1 are overlapped on each other in the longitudinal direction, no problems are caused. When the coils are arranged being overlapped on each other, even if the area of the side 12a of the lens holder 12 is small, it becomes possible to attach a large coil to the side 12a of the lens holder 12. In this case, the third coil Tr1, which is overlapped on the front side, is fixed onto the side 12a of the lens holder 12 via the bottom board 12d for filling the step formed on the reverse side of the third coil Tr1.

As shown in FIGS. 3A and 3C, the magnet 31 is divided into four regions by the x-axis, which is opposed to straight line A connecting the centers of the first coil F11 and the second coil F21, and by the y-axis which is opposed to straight line B passing at the center of the third coil Tr1 and perpendicular to straight line A. Further, N-pole and S-pole alternately appear in the four regions so that the regions adjacent to each other can be of magnetic polarities different from each other.

Due to the above configuration, for example, a clockwise electric current flows in the first coil F11 and a counterclockwise electric current flows in the second coil F21, a downward drive force is generated. When opposite electric currents flow in the coils, an upward drive force is generated. In this way, a positional correction in the focusing direction can be realized.

When a clockwise electric current flows in the first coil F11 and the second coil F21, a drive force is generated so that the left goes down and the right goes up. When an opposite electric current flows, a drive force is generated so that the left goes up and the right goes down. Due to the foregoing, a correction of the tilting angle can be realized.

When a clockwise electric current flows in the third coil Tr1, a clockwise drive force is generated. When a counterclockwise electric current flows in the third coil Tr1, a counterclockwise drive force is generated. Due to the foregoing, a positional correction in the tracking direction can be realized.

As shown in FIG. 2, on the opposite side 12b of the lens holder 12, the first coil F12, the second coil F12 and the third coil Tr2 are provided in an arrangement symmetrically with the side 12a. Corresponding to the above arrangement of the coils, in the magnet 32 on the opposite side, the magnetic poles are formed symmetrically with the magnet 31.

In this connection, since a motion in the same direction can be given when directions of both the magnetic pole and the electric current are inverted, when the direction of the magnetic pole of the magnet 31 is reversed and the direction of the electric current of each coil F11, F21, Tr1 opposed to the magnet 31 is also reversed, the driving can be conducted in the same way. Concerning the magnetic poles of the magnet 32 on the opposite side and the coils F12, F22, Tr2 opposed to the magnetic poles, the circumstances are the same.

Concerning the arrangement of the first coil F11, the second coil F21 and the third coil Tr1, the first coil F11 and the second coil F21 are arranged on the upper side and the third coil Tr1 is arranged on the lower side. Concerning the regions in which the magnetic poles of the magnet appear, the upper side and the lower side are inverted according to the coils, the driving can be conducted in the same way.

FIG. 5 is a view showing an example of the circuit diagram in which a connecting relation between the square flat coils, which are provided in the lens holder, and the wires is shown.

Concerning the six coils of F11, F21, Tr1, F12, F22 and Tr2 attached to the lens holder 12, two coils, which are respectively provided on one side 12a and the other side 12b symmetrically with each other, are formed into one set, and the one set of coils are connected between the same wires. That is, the first coils F11 and F12 (the first system coils), which are respectively provided on the sides 12a and 12b, are connected in series between the first wire W1 and the common wire W4. In the same manner, the second coils F21 and F22 (the second system coils), which are respectively provided on the sides 12a and 12b, are connected in series between the second wire W2 and the common wire W4, and the third coils Tr1 and Tr2 (the third system coils), which are respectively provided on the sides 12a and 12b, are connected in series between the third wire W3 and the common wire W4.

The first wire W1, the second wire W2 and the third wire W3, which are in the four wires, are respectively connected to the output circuit for controlling an output electric current. Due to this structure, electric currents If1, If2, Itr respectively flowing in wires W1 to W3 can be controlled. Common wire W4 is connected, for example, to the ground electric potential, so that the electric currents of the third wire W3, the first wire W1 and the second wire W2 can be made to flow in common wire W4.

According to the above wiring, by the addition electric current (If1+If2) of electric currents If1, If2 flowing in wires W1, W2, a quantity of drive in the focusing direction can be controlled. By the difference current (If1−If2) of electric currents If1, If2 flowing in wires W1, W2, a quantity of drive in the tilting angle direction can be controlled. By electric current Itr flowing in wire W3, a quantity of drive in the tracking direction can be controlled. The above addition electric current and the difference electric current can be independently changed by electric currents If1, If2 flowing in the first wire W1 and the second wire W2. Therefore, the drive in the focusing direction, the tilting angle direction and the tracking direction can be independently conducted by the three electric currents of If1, If2, Itr.

In this connection, when both winding directions of the winding wires of the first coils F11, F12 are inverted or when the terminal connected to wire W1 and the terminal connected to common wire W4 are alternated with each other, both directions of the electric currents flowing in the first coils F11, F12 are inverted. Therefore, the drive in the tilting angle direction can be conducted by the addition electric current (If1+If2), and the drive in the focusing direction can be conducted by the difference electric current (If1−If2). Concerning the second coils F21, F22, the circumstances are the same. In other words, when any wiring system is adopted, the drive of three axes can be controlled in the same way.

As described above, according to the drive unit for driving an objective lens of an optical head of this embodiment, the drive of three axes of the focusing direction, the tracking direction and the tilting angle direction can be conducted by the six square flat coils of F11, F12, F21, F22, Tr1, Tr2 and the magnets 31, 32 arranged being opposed to the coils. Therefore, a compact drive unit for driving an objective lens capable of conducting a correction of three axes can be composed at a low manufacturing cost.

Further, since the plurality of coils attached to the lens holder 12 are composed of the same structure, the costs of parts can be reduced, that is, the manufacturing cost can be decreased.

It is sufficient to provide four wires in order to conduct the drive of three axes, and the number of wires to support the lens holder 12 can be made to be four. Therefore, the assembling process can be relatively simplified. Even when the assembling process is simplified, the operation characteristic can be made stable.

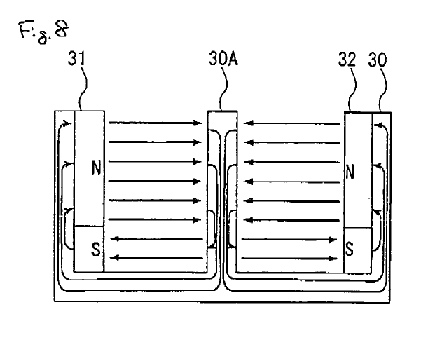

The drive unit for driving an objective lens of this embodiment does not have yokes for making the lines of magnetic force, which extend from the magnet, more perpendicular in the magnet holder 30. (The structure in which the yokes 30A, 30B are provided is shown in FIG. 7.) Therefore, the structure of the lens holder 12 can be more simplified. Accordingly, the secondary frequency of the lens holder 12 can be increased, and the generation of the secondary resonance can be suppressed.

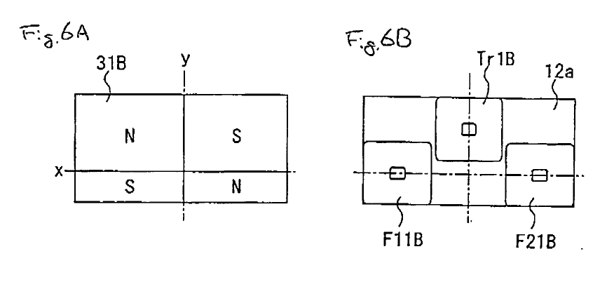

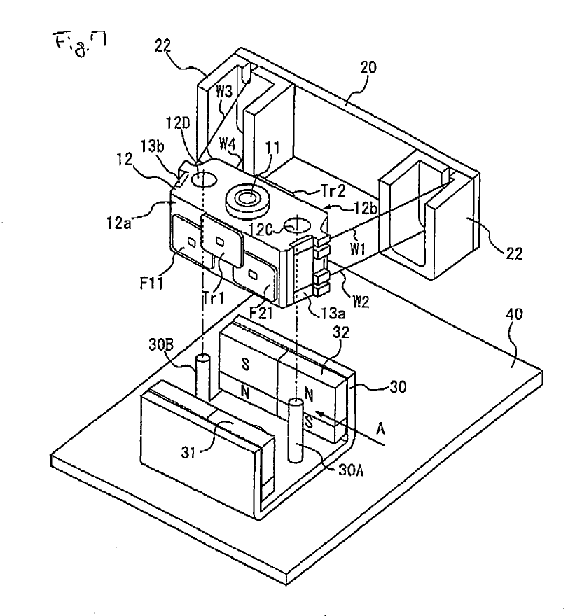

FIGS. 6A and 6B are views showing another example of arranging the square flat coils fixed to the lens holder. FIG. 6A is a front view of the magnet face opposed to the lens holder, and FIG. 6B is a front view of the square flat coil face opposed to the magnet.

In the embodiment shown in FIGS. 1 through 5, an example is shown in which three square flat coils provided on one side of the lens holder 12 are partially overlapped on each other. However, as shown in FIG. 6, the three square flat coils may be, arranged on one side of the lens holder 12 so that they are not overlapped on each other. In this case, if the area of the side 12a of the lens holder 12 is the same, the dimensions of square flat coils Tr1B, F11B, F21B must be made to be somewhat smaller than the dimensions of square flat coils Tr1B, F11B, F21B shown in FIG. 3. However, this arrangement is advantageous in that three coils Tr1B, F11B, F21B can be arranged equally close to the magnet 31B.

FIG. 7 is a view showing another embodiment of the drive unit for driving an objective lens of the present invention. FIG. 8 is a view showing operation of the yokes 30A, 30B, wherein FIG. 8 is a side view taken in the direction of arrow A in FIG. 7.

There are provided no yokes for making the lines of magnetic force, which extend from the magnets 31, 32, more perpendicular in the embodiment shown in FIG. 1. However, the following structure may be adopted. As shown in FIG. 7, the yokes 30A, 30B are provided in the magnetic holder 30, and the through-holes 12C, 12D are formed in portions of the lens holder 12 where the yokes 30A, 30B are inserted. In this case, the magnetic holder 30 is composed of a magnetic body.

In the embodiment of the present invention, concerning the cross-sectional shape of the lens holder 12, the lateral width (the width in the traverse direction along the upper and the lower side) is long, and the longitudinal width is short. Therefore, the yokes 30A, 30B may be provided on the right and the left of the objective lens 11. Due to the foregoing, the yokes 30A, 30B can be added to the lens holder 12 without changing the horizontal is cross-sectional shape of the lens holder 12.

When the yokes 30A, 30B are provided as described above, as shown in FIG. 8, the lines of magnetic force extending from the magnets 31, 32 can be made to be more perpendicular than the lines of magnetic force in the case where no yokes are provided. Due to the foregoing, drive control conducted by electric currents If1, If2, Itr can be stabilized and an intensity of the drive force can be increased.

In this connection, it should be noted that the present invention is not limited to the above specific embodiment, and variations can be made. For example, concerning the third system coil in which the electric current of wire W3 flows, coils Tr1 and Tr2 are provided on two sides of 12a and 12b of the lens holder 12, however, one coil may be omitted and only one coil may be provided on one side. Alternatively, two coils may be provided on one side so that driving forces can be generated in the same direction. Concerning the first system coils F11 , F12 in which the electric current of wire W1 flows and the second system coils F21, F22 in which the electric current of wire W2 flows, the circumstances are the same.

In the embodiment explained above, the present invention is applied to a drive unit for driving an objective lens of an optical head that is mounted on DVD W2 driving unit. It is also possible to apply the present invention to various disk drive units such as a drive unit for driving an objective lens of an optical head used for an optical magnetic disk and a drive unit for driving an objective lens of an optical head mounted on a disk drive used for recording and reproducing with blue and violet laser beams.

As explained above, according to the present invention, the driving of three axes can be conducted by the coils, which are provided in the lens holder, and the magnets provided outside the lens holder. Further, the lens holder can be supported by four wires. Therefore, the optical head can be made compact and the manufacturing cost can be reduced. Furthermore, it is possible to obtain a stable operation characteristic.

Further, when the coils provided in the lens holder are composed of the same structure, the costs of parts can be reduced, that is, the manufacturing cost can be further reduced.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A drive unit for driving an objective lens of an optical head, the drive unit comprising:
a lens holder that holds the objective lens;
first, second and third system coils each including a pair of square flat coils of a same size and respective pair of square flat coils being provided on both side of the lens holder, the first and the second system coils being arranged in a direction perpendicular to the focusing direction on each side of the lens holder, and the third system coils being arranged at a position displaced in the focusing direction from a central position of the first and the second system coils on each side of the lens holder;
a first wire, a second wire, a third wire and a common wire that support the lens holder and supply an electric current to corresponding coils, the first wire and the common wire being connected to the first system coils, the second wire and the common wire being connected to the second system coils, and the third wire and the common wire being connected to the third system coils;
two ferromagnetic bodies each being respectively provided to oppose to both sides of the lens holder, each ferromagnetic body being divided into four regions by x-axis and y-axis, which are perpendicular to each other, each region being magnetized to N-pole or S-pole so that the regions adjacent to each other can be magnetized to a different polarity, the x-axis being opposed to a straight line connecting the centers of the first system coil and the second system coil, the y-axis being opposed to a straight line passing at the center of the third system coil, wherein
an amount of displacement of the objective lens in the focusing direction is controlled by an added value or subtracted value of the electric currents flowing in the first and the second wire, an amount of displacement of the objective lens in the tilting angle direction is controlled by a subtracted value or added value of the electric currents flowing in the first and the second wire, and an amount of displacement of the objective lens in the tracking angle direction is controlled by an electric current flowing in the third wire.

2. A drive unit for driving an objective lens of an optical head, the drive unit comprising:
a lens holder for holding the objective lens;
a plurality of coils provided on sides of the lens holder;
a plurality of wires that supplies electric currents to the coils and supports the lens holder; and
a magnet that generates a magnetic field in a portion where the coils are provided,
wherein the plurality of wires comprise a first wire, a second wire, a third wire and a common wire,
wherein the plurality of coils comprise a first system coil connected between the first wire and the common wire, a second system coil connected between the second wire and the common wire, and a third system coil connected between the third wire and the common wire, and
wherein the lens holder is to be displaced in a focusing direction, in a tilting angle direction and in a tracking direction independently from each other by the three electric currents respectively flowing in the first, the second and the third wire.

3. The drive unit according to claim 2, wherein each of the first, the second and the third system coil comprise a pair of coils each provided on both side of the lens holder.

4. The drive unit according to claim 2, wherein the first and the second system coil are arranged in a direction perpendicular to the focusing direction, and
wherein the third system coil is arranged at a position displaced in the focusing direction from a central position of the first and the second system coils.

5. The drive unit according to claim 4, wherein the magnet comprises a ferromagnetic body being provided to oppose to the side of the lens holder, the ferromagnetic body being divided into four regions by x-axis and y-axis, which are perpendicular to each other, each region being magnetized to N-pole or S-pole so that the regions adjacent to each other can be magnetized to a different polarity, the x-axis being opposed to a straight line connecting the centers of the first system coil and the second system coil, the y-axis being opposed to a straight line passing at the center of the third system coil.

6. The drive unit according to claim 4, wherein an amount of displacement of the objective lens in the focusing direction is controlled by an added value or subtracted value of the electric currents flowing in the first and the second wire, an amount of displacement of the objective lens in the tilting angle direction is controlled by a subtracted value or added value of the electric currents flowing in the first and the second wire, and an amount of displacement of the objective lens in the tracking angle direction is controlled by an electric current flowing in the third wire.

7. The drive unit according to claim 2, wherein each of the plurality of coils comprises a square flat coil of a same size.
